(19) United States
(12) Patent Application Publication
(10) Pub. No.: US 2010/0310703 A1
(43) Pub. Date: Dec. 9, 2010

(54) Thermoformer drive and tilt system

(76) Inventor: Brian D. Schlepp, Yakima, WA (US)

Correspondence Address: Svendsen Legal, LLC, P.O. Box 10627, Yakima, WA, 98909, US

(21) Appl. No.: 12/455,808

(22) Filed: Jun. 5, 2009

(51) Int. Cl. B29C 51/20

(52) U.S. Cl. 425/399

(57) ABSTRACT

A drive and tilt system for a thermoforming press to simultaneously operate the vertical drive and angular tilt of a platen in the thermoforming press, employing a motor driven crank mechanism. The drive and tilt system provides for smooth, efficient and reliable cyclic operation at the high rate required in the thermoforming press. The drive and tilt system includes a drive mechanism, a lift mechanism, and tilt mechanism. The drive mechanism is powered by a drive motor, for rotating a lift shaft. The lift mechanism raises and lowers a tilt-able platen along with a carriage through the rotation of the lift shaft. The tilt mechanism is powered from a tilt motor mounted in the carriage. The tilt mechanism tilts the platen, which is also raised or lowered by the lift mechanism.

### TECHNICAL FIELD

The invention relates to a drive and tilt system for a thermoforming press. More particularly, the invention relates to a system of simultaneous vertically driving and angularly tilting of a platen in a thermoforming press, with a servo motor driven crank mechanism. The drive and tilt system provides for smooth, efficient and reliable cyclic operation at the high rate required in the thermoforming press.

### BACKGROUND OF THE INVENTION

The continuous sheet thermoforming of synthetic plastic articles is a widely utilized industrial process. Thermoformers can take a variety of configurations, but each type includes the same basic stations. The plastic raw material is utilized in rolls or precut sheets. Common thermoformers include rotary machines, single stage devices, or as preferred for the purposes of the present invention, an in-line, continuous sheet thermoformer.

For conventional “in-line” or continuous feed thermoforming operations, a high-speed and secure clamping of two platens deforms the continuous plastic sheet into the desired product. The platens are preferably utilized in pairs, with one platen contacting a pre-heated sheet of plastic material from one side, while the second platen contacts the sheet from the other side. The two platens reciprocate in unison to contact and form the thermoformed article product, which may be a plurality of articles, from the continuous sheet of thermoplastic material. With tilting platen presses, one of the two platens includes a tilting motion after un-clamping, to facilitate ejection of the thermoformed product from the platen.

At the feed end of the in-line thermoforming process, a thin sheet of plastic is positioned at an in-feed or loading station. The loading station may receive the plastic sheet directly from an extruder, or from a rolled sheet of material. The thin plastic sheet is fed continuously, from the loading station to a heating station and then to a forming station. At the heating station the sheet is heated to the required forming temperature. In the forming station the sheet is deformed or molded into the desired shape. This forming is accomplished by direct compression or differential pressure forces, or a combination of these forces to fit the shape of the mold within the former.

For the thermoforming process, the sheet of thermoplastic material is heated until it becomes soft and pliable, but not fluid. The heated sheet is briefly held within the mold of the thermoforming press for forming. Some thermoforming presses rely on a tilting platen to provide additional advantages in speed and operational efficiency. The tilting platen is able to eject the thermoformed product more quickly than non-tilting platens. Higher processing speeds from a tilting patten can only be realized if a high degree of consistency and precision are maintained.

Presently, “cam and follower” mechanisms actuate the platens of many high speed thermoforming presses. Such mechanism are inherently prone to off-balanced operation due to the orbital rotations of cams and lobes. Additional operational speed limits, especially in tilting platen systems, are attributable to the mechanical limitations of cams and their associated follower mechanisms.

A new system of press operation is needed that speeds and smooths the action of a thermoformer, and aids in the efficient and high speed operation of the tilting thermoforming press, at the dynamic forces required. The present invention addresses the speed limiting problems for prior tilting platen thermoformers by providing a new system of driving and tilting the platen components of a thermoforming press. The aspects and advantages of the invention will become apparent from consideration of the following figures and description.

### BRIEF DESCRIPTION OF DRAWINGS

FIG. 1A is a partially phantom lined isometric view of a thermoforming press in a closed position, with a drive and tilt system according to an embodiment of the invention;

FIG. 1B is a partially phantom lined isometric view of a thermoforming press in an open position, with a drive and tilt system according to an embodiment of the invention;

FIG. 2A is a partially phantom lined side view of a thermoforming press in a closed position, with a drive and tilt system according to an embodiment of the invention;

FIG. 2B is a partially phantom lined side view of a thermoforming press in an open position, with a drive and tilt system according to an embodiment of the invention;

FIG. 3A is a schematic view of a portion of a thermoforming press in a closed position, with a drive and tilt system according to an embodiment of the invention; and

FIG. 3B is a schematic view of a portion of a thermoforming press in an open position, with a drive and tilt system according to an embodiment of the invention.

Reference characters included in the above drawings indicate corresponding parts throughout the several view, as discussed herein. The description herein illustrates one preferred embodiment of the invention, in one form, and the description herein is not to be construed as limiting the scope of the invention in any manner. It should be understood that the above listed figures are not necessarily to scale and that the embodiments are sometimes illustrated by fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

The present invention includes a drive and tilt system for a tilting thermoforming press. The tilting platen of the press rotates with each thermoforming cycle, as commonly employed in certain in-line thermoforming process machines. The system includes the linkages required for simultaneous actuation of thermoforming platens, to vertically drive and angularly tilt the platen, with the aid of servo motor driven crank shaft mechanisms.

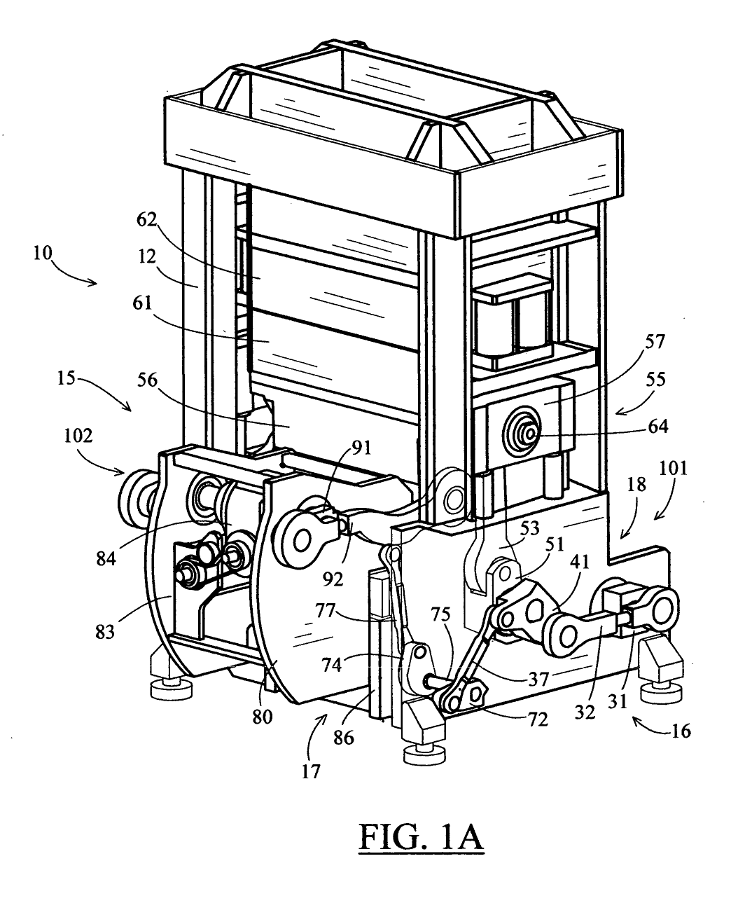

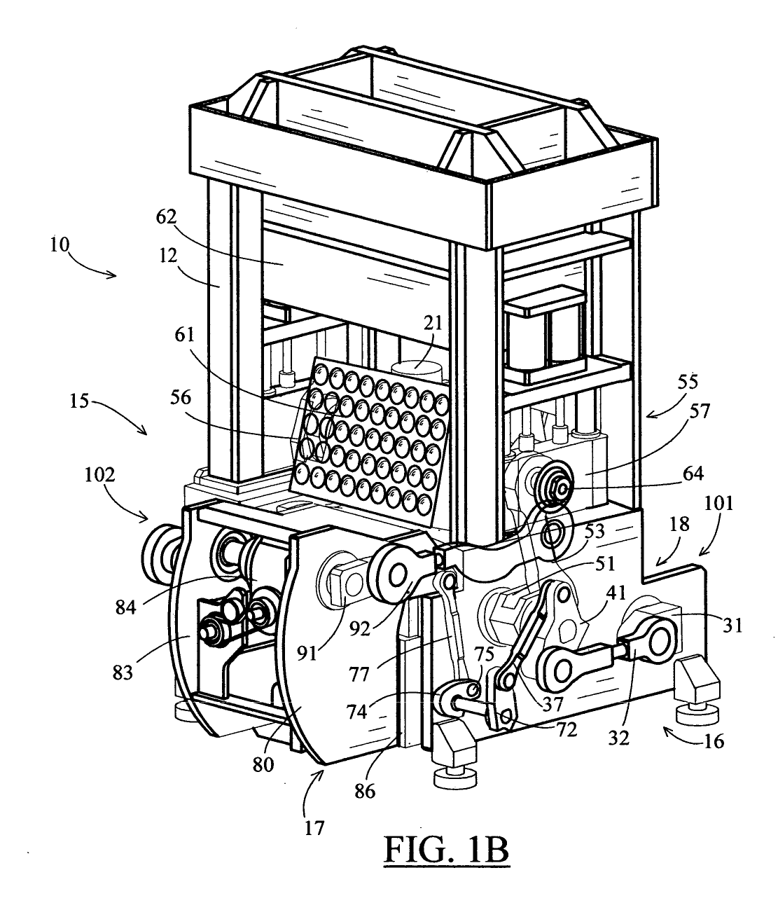

A preferred embodiment of the system of the present invention is shown in FIGS. 1A through 3B. FIGS. 1A and 1B show an isometric perspective view of a thermoforming press 10, simply referred to herein as a “press.” The high dynamic forces involved with the operation of the press required the press to include a heavy over-frame 12, to anchor the moving components of the press. The drive and tilt system 15 of present invention includes a drive mechanism 16, a lift mechanism 17 and a tilt mechanism 18, all mounted to the over-frame, as detailed herein.

### Drive Mechanism

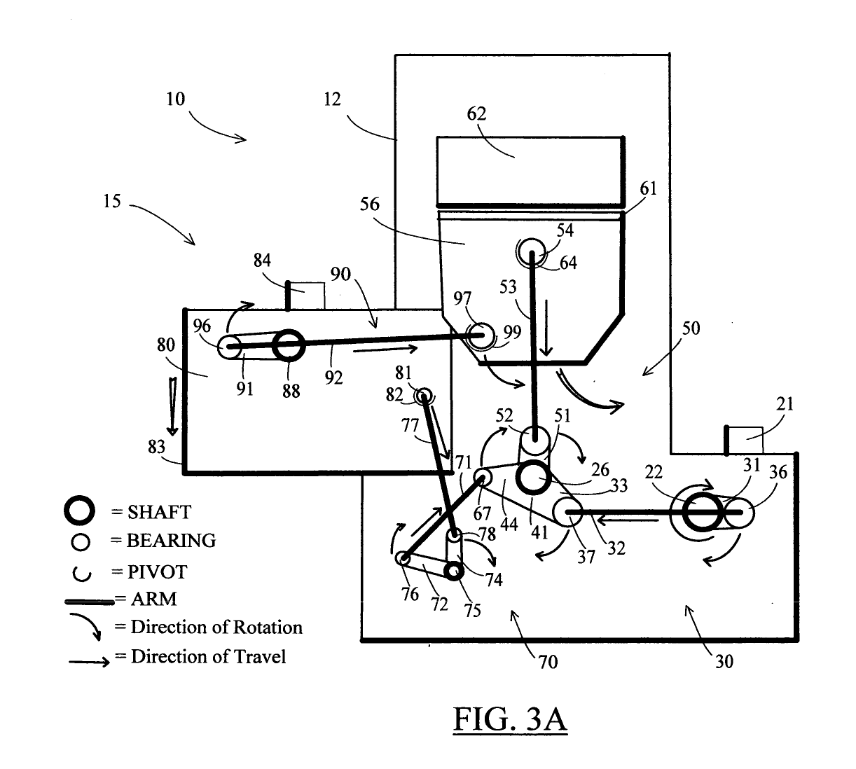

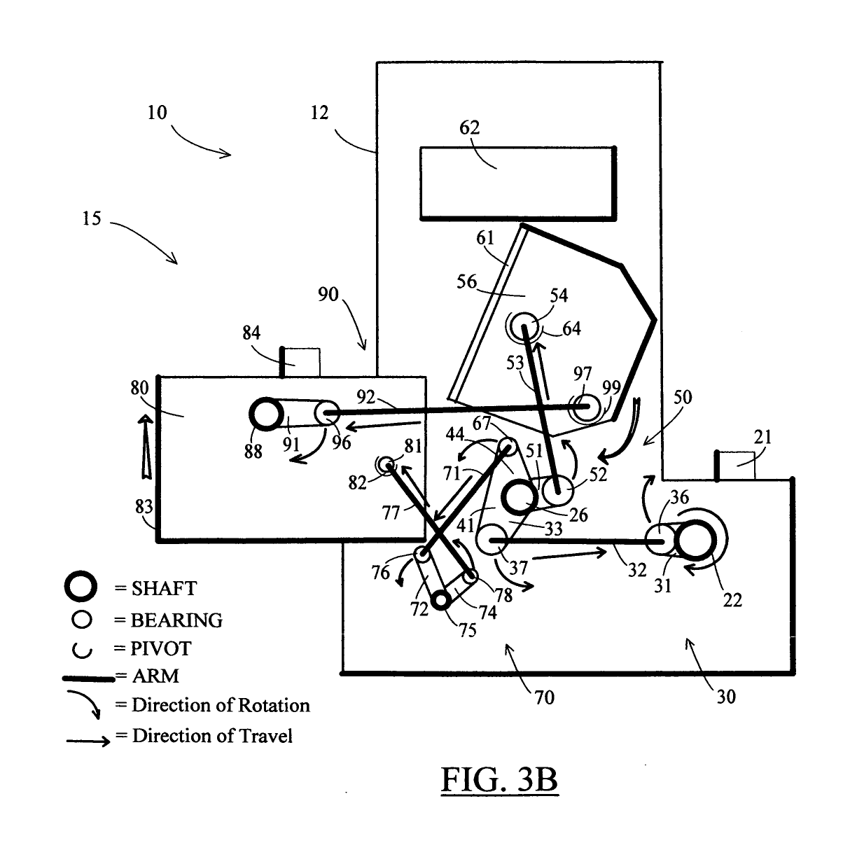

The drive mechanism 16 relies on a drive motor 21 mounted to the over-frame of the thermoforming press 10. The drive motor is preferably an electrical motor, sized and equipped with the necessary gearing and transmission by one skilled in such selections, to rotate a drive shaft 24, configured as schematically shown in FIGS. 3A and 3B.

The drive motor 21 is preferably electric, but may be hydraulicly powered, or any other conventional alternative. The drive motor with a single direction of rotation, as it rotates the drive shaft 24, and therefore the drive crank 31. Alternatively, the drive motor can be configured to operate in a reversing, two-directional rotation motion, if desired. This alternative, or “rocking” range of motion can be employed to alternatively operate the press 10 without trimming the finished product, and locking out the tilt mechanism 18.

A drive linkage 30 connects the drive shaft 22 to a lift shaft 26, the drive linkage actuated by the rotation of the drive shaft, as shown in FIGS. 1A and 1B. The drive linkage preferably includes a drive crank 31, a drive arm 32, and a lift shaft rocker 41.

Preferably, the drive crank 31 mounts to the drive shaft 22 with a clamping attachment, which may be keyed to prevent unwanted rotation of the drive shaft within the drive crank. The drive crank also includes a drive crank-arm bearing 36, as schematically shown in FIGS. 3A and 3B, and the drive arm 32 rotatably attaches to the drive crank at the drive crank-arm bearing.

The drive arm 32 interconnects the drive crank 31 to a lift shaft rocker 41. The drive crank-arm bearing 36 of the drive arm rotate-ably attaches to the drive crank 31, and a drive arm-rocker bearing 37 rotate-ably attaches to the lift shaft rocker. The drive crank-arm bearing preferably at the opposite end of the drive arm from the drive arm-rocker bearing.

### Lift Mechanism

Another component feature of the drive ant tilt system 15 of the present invention is the lift mechanism 17, which serves to raise and lower a tilt platen assembly 55. As shown in FIGS. 1A and 1B, the lift shaft rocker 41 mounts to the lift shaft 26, preferably with an asymmetric attachment, to prevent unwanted rotation of the lift shaft rocker in the lift shaft. The lift shaft rocker includes a drive rocker arm 43 positioned to oppose a carriage rocker arm 44. The drive rocker arm connects to the drive arm 32 and the carriage-rocker arm connects to a primary carriage arm 71. Preferably, the drive rocker arm of the lift shaft rocker includes the drive arm-rocker bearing for rotate-ably attaching to the drive arm 32, and the carriage rocker arm includes a carriage arm rocker bearing 47 for rotate-ably attaching to the primary carriage arm.

The lift shaft 26 rocks rotationally, by action of the lift shaft rocker 41. A lift linkage 50 connects the lift shaft to the tilt platen assembly 55. The tilt platen assembly includes a tilt body 56 that is pivot-able within a lift frame 57. The tilt body includes a tilt platen 61, and the tilt platen can mate to, and momentarily clamp at high pressure with an over platen 62, to form the article or articles to be manufactured by the action of the press 10. The articles of manufacture may be cups, containers, or any such items as commonly formed from a continuous sheet of plastic material with such press machines, as are well known to those skilled in thermoforming technologies.

The lift linkage 50 of the drive and tilt system 15, is actuated by the rocking rotation of the lift shaft 26, and the lift linkage preferably includes a lift crank 51, and a lift arm 53. The lift crank mounts to the lift shaft, and the lift crank includes a lift crank-arm bearing 52. The lift arm rotateably attaches to the lift crank at the lift crank-arm bearing, to rotate and reciprocate with the action of the lift crank about the lift shaft.

The lift arm 53 inter-connects the lift crank 51 to the tilt body 56 of the tilt platen assembly 55 at a tilt platen-lift bearing 54. The tilt platen-lift bearing is located on the lift arm, at the end opposite the lift crank-arm bearing 52. Additionally, as schematically shown in FIGS. 3A and 3B, the lift frame 57 of the tilt platen assembly includes a lift pivot 64, and the tilt platen-lift bearing rotate-ably connects to the lift pivot. The tilt platen assembly rapidly raises and lowers for each process cycle of the press 10, by the reciprocating action of the lift arm.

### Tilt Mechanism

The tilt mechanism 18 of the present invention serves to “tilt” or rotate the lift frame 57 of the tilt platen assembly 55. A carriage linkage 70 mechanically inter-connects the lift shaft 26 to a carriage 75, with the carriage linkage actuated by the rocking rotation of the lift shaft. The lift linkage includes the primary carriage arm 71, which connects to a primary carriage crank 72. The carriage crank mounts to a carriage shaft 75. Additionally, a secondary carriage crank 74 mounts to the carriage shaft, and a secondary carriage arm 77 rotate-ably connects to the secondary carriage crank.

The primary carriage arm 71 inter-connects the carriage rocker arm 44 of the lift shaft rocker 41 to the primary carriage crank 72, at a primary carriage arm-rocker bearing 67. The primary carriage crank mounts to the carriage shaft 75, and the primary carriage crank includes a primary carriage arm-crank bearing 76. The primary carriage arm rotate-ably attaches to the primary carriage crank at the primary carriage arm-crank bearing.

The secondary carriage crank 74 also mounts to the carriage shaft 75. The secondary carriage crank includes a secondary carriage arm-crank bearing 78. The secondary carriage arm 77 rotateably attaches to the secondary carriage crank at the secondary carriage arm-crank bearing. The secondary carriage crank 74 rotationally rocks by action of the primary carriage crank 72 on the carriage shaft 75. The secondary carriage arm 77 also includes a secondary carriage-arm frame bearing 81 at the opposite end to the secondary carriage arm-crank bearing 78. The secondary carriage arm inter-connects the secondary carriage crank to the carriage 80 at a carriage frame pivot 82, with the secondary carriage-arm frame bearing rotate-ably connected to the secondary carriage-arm frame bearing. The carriage is movable by the raising and lowering action of the secondary carriage arm on the carriage frame pivot.

The carriage 80 also includes a sliding frame 83 and a tilt motor 84 mounted within the sliding frame, as shown in FIGS. 1A and 1B. The sliding frame of the carriage moves upon a carriage rail 86, and the carriage rail is mounted on the over frame 12 of the press 10. The carriage can move on the carriage rail in a motion that is parallel to the actuated motion of the lift frame 57, which is as moved by the lift arm 53 and the lift mechanism 17 of the drive and tilt system 15.

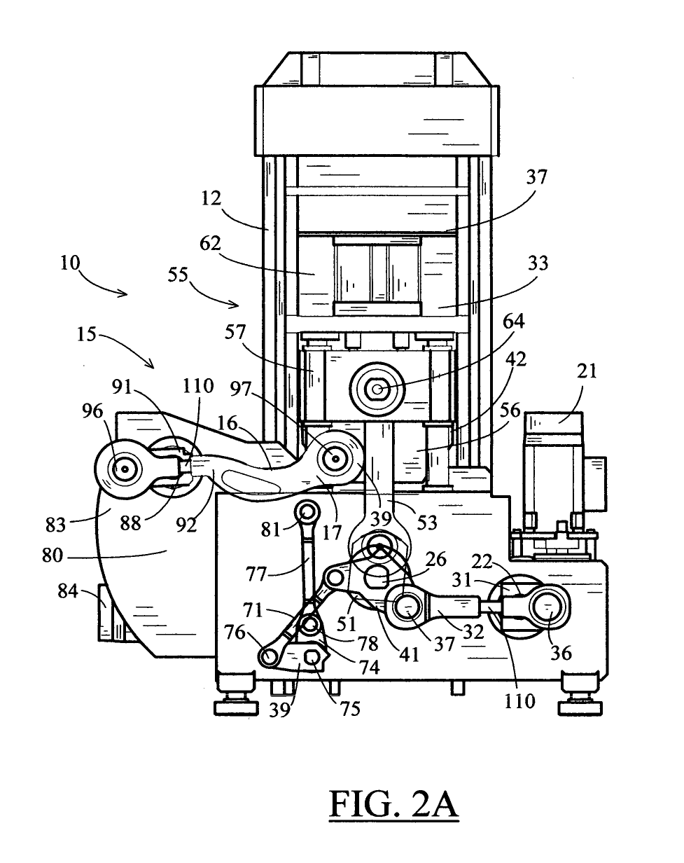

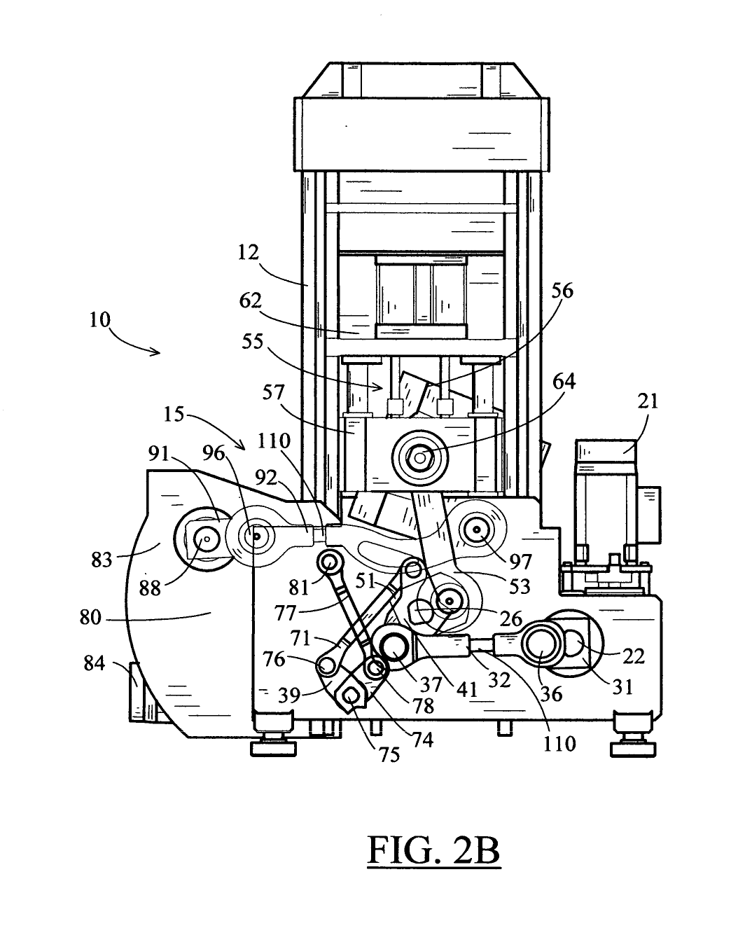

Most preferably, the secondary carriage 77 arm, and the lift arm 53 act in a strictly parallel orientation, and have the same length, as shown in FIGS. 2A and 2B. This desired geometric relationship serves to precisely maintain the movement of the carriage 80 along the carriage rail 86, in an exact match with the strictly parallel action of the lift frame 57 within the over frame 12.

A tilt linkage 90 mechanically inter-connects the carriage 80 to the tilt platen assembly 55. A tilt shaft 88 rotated by the tilt motor 84, drives the tilt linkage, which then rotates the tilt platen 61 within the lift frame 57 of the tilt platen assembly. The tilt linkage includes tilt crank, which moves a tilt arm. The tilt linkage is actuated by the rotation of the tilt shaft 88, which is rotated by the tilt motor 84. The tilt linkage includes a tilt crank 91 and a tilt arm 92. Preferably, the tilt crank mounts to the tilt shaft with a clamping attachment, which may be keyed to prevent unwanted rotation of the tilt shaft within the tilt crank. The tilt arm includes a tilt crank-arm bearing 96, and the tilt arm rotate-ably attaches to the tilt crank at the tilt crank-arm bearing.

The tilt motor 84 is preferably an eclectic powered or alternately a hydraulic motor with a reversing ability, to rotate the tilt shaft 88, and therefore the tilt crank 91, in a rocking, two-directional motion. Alternatively, the tilt motor could be configured to operate in a constant direction of rotation, if desired.

The tilt arm 92 inter-connects the tilt crank 91 to the tilt body 56 of the tilt platen assembly at a tilt arm-body bearing 97. The tilt body of the tilt platen assembly 55 including a tilt pivot 99, and the tilt arm-body bearing rotate-ably connects to the tilt pivot. The reciprocating action of the tilt arm 92 cyclically rotates or tilts the tilt body about the lift pivot 64. By this tilting action, the tilt platen 61, as mounted to tilt body is rotate-able within the lift frame 57, and can tilt away from clamping alignment with the over platen 62. The over platen mounted to the over frame 12 of the thermoformer press 10.

The above descriptions pertain to a singular mechanism for the drive and tilt system 15. However, as preferred, and shown in FIGS. 1A and 1B, a preferred embodiment of the drive and tilt system includes a parallel acting set of mechanisms, working together. Namely, a primary mechanism 101, as described in detail herein and including the drive mechanism 16, the lift mechanism 17 and the tilt mechanism 18, work in concert with a secondary system 102, duplicating the action of the primary mechanism on the opposite side of the thermoforming press 10. Preferably, both the primary and secondary mechanism are driven by the common drive motor 21, and the common tilt motor 84, with the respective drive shaft 22, lift shaft 26 and tilt shaft 88, also in common to both the primary and secondary systems.

To best “tune” or adjust the action of the drive arm 32 and the tilt arm 92 about their respective pivots bearings and shafts, especially when employed with the additional, secondary mechanism 102, as discussed above, the drive arm and the tilt arm preferably include “turnbuckles” 110, as shown in FIGS. 2A and 2B. Turnbuckles are well known in to designers of heavy equipment and are used for the purpose of changing the length of mechanical arms. The arms can be easily shortened or lengthened, as desired, to be match the length of parallel acting arms, and prevent binding between the arms, and providing the ability to adjust the stroke length of the arm.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. A drive and tilt system for a thermoforming press, the drive and tilt system comprising:
a drive motor mounted to an over-frame of the thermoforming press;
a drive shaft rotated by the drive motor;
a drive linkage for connecting the drive shaft to a lift shaft, the drive linkage actuated by the rotation of the drive shaft, the drive linkage including a drive crank, a drive arm, and a lift shaft rocker,
the drive crank mounted to the drive shaft, the drive crank including a drive crank-arm bearing, and the drive arm rotatably attached to the drive crank at the drive crank-arm bearing;
the drive arm for connecting the drive crank at the drive crank-arm bearing to the lift shaft rocker at a drive arm-rocker bearing;
the lift shaft rocker mounted to the lift shaft, the lift shaft rocker including a drive rocker arm, and a carriage rocker arm, the drive rocker arm rotatably attached to the drive arm at the drive arm-rocker bearing, and the carriage rocker arm rotatably attached to the carriage rod at a carriage rod-rocker bearing;
the lift shaft rotationally rocked by action of the lift shaft rocker;
a lift linkage connecting the lift shaft to a tilt platen assembly, the lift linkage actuated by the rocking rotation of the lift shaft, the tilt platen assembly including a tilt body pivot-able within a lift frame, the tilt body including a tilt platen, the tilt platen mate-able with an over platen;
the lift linkage including a lift crank, and a lift arm;
the lift crank mounted to the lift shaft, the lift crank including a lift crank-arm bearing, and the lift arm rotatably attached to the lift crank at a lift crank-arm bearing;
the lift arm for connecting the lift crank at the lift crank-arm bearing to the tilt body of the tilt platen assembly at a tilt platen-lift bearing;
the lift frame of the tilt platen assembly including a lift pivot, and the tilt platen-lift bearing rotatably connected to the lift pivot, the tilt platen assembly cyclically raised and lowered by reciprocating action of the lift arm;
a carriage linkage connecting the lift shaft to a carriage, the carriage linkage actuated by the rocking rotation of the lift shaft, the carriage linkage including a primary carriage rod, a primary carriage crank, a carriage shaft, a secondary carriage shaft and a secondary carriage rod;
the primary carriage rod for connecting the carriage rocker arm of the lift shaft rocker to the primary carriage crank at a primary carriage rod-rocker bearing;
the primary carriage crank mounted to the carriage shaft, the primary carriage crank including a primary carriage rod-crank bearing, and the primary carriage rod rotatably attached to the primary carriage crank at the primary carriage rod-crank bearing;
the carriage shaft including a secondary carriage crank, the secondary carriage crank rotated by action of the primary carriage crank on the carriage shaft;
the secondary carriage rod for connecting the secondary carriage crank to the carriage at a carriage-rod bearing;
the secondary carriage crank mounted to the carriage shaft, the secondary carriage crank including a secondary carriage rod-crank bearing, and the secondary carriage rod rotatably attached to the secondary carriage crank at the secondary carriage rod-crank bearing;
the carriage including a tilt linkage connected to a tilt shaft driven by a tilt motor, the tilt motor mounted to a sliding frame, the sliding frame movable on a carriage rail, the carriage rail mounted on the over frame, and the carriage movable in a motion parallel to the action of the lift frame, as moved by the lift arm;
the tilt linkage for connecting the tilt shaft to the tilt body of the tilt platen assembly, the tilt linkage actuated by the rotation of the tilt shaft, the tilt linkage including a tilt crank, and a tilt arm;
the tilt crank mounted to the tilt shaft, the tilt crank including a tilt crank-arm bearing, and the tilt arm rotatably attached to the tilt crank at the tilt crank-arm bearing;
the tilt arm for connecting the tilt crank at the tilt crank-arm bearing to the tilt body of the tilt platen assembly at a platen-tilt arm-platen bearing; and
the tilt body of the tilt platen assembly including a tilt pivot, and the platen-tilt arm bearing rotatably connected to the tilt pivot, the tilt body cyclically tilted by reciprocating action of the tilt arm, and, the tilt platen rotate-able on the lift frame, away from clamping alignment with the over-platen.

2. A drive and tilt system for a thermoforming press, the drive and tilt system comprising:
a drive motor mounted to an over-frame of the thermoforming press;
a drive shaft rotated by the drive motor;
a drive linkage for connecting the drive shaft to a lift shaft, the drive linkage actuated by the rotation of the drive shaft, and the lift shaft rotationally rocked by action of the drive linkage;
a lift linkage connecting the lift shaft to a tilt platen assembly, the lift linkage actuated by the rocking rotation of the lift shaft, the tilt platen assembly including a tilt body pivot-able within a lift frame, the tilt body including a tilt platen, the tilt platen mate-able with an over-platen;
the lift frame of the tilt platen assembly including a lift pivot, and the lift linkage rotatably connected to the lift pivot, the tilt platen assembly cyclically raised and lowered by reciprocating action of the lift linkage;
a carriage linkage connecting the lift shaft to a carriage, the carriage linkage actuated by the rocking rotation of the lift shaft, the carriage including a tilt linkage, the tilt linkage connected to a tilt shaft driven by a tilt motor, the tilt motor mounted to a sliding frame of the carriage, the sliding frame movable on a carriage rail, the carriage rail mounted on the over-frame, and the carriage movable in a motion parallel to the action of the lift frame, as moved by the lift arm;
the tilt linkage for connecting the tilt shaft to the tilt body of the tilt platen assembly, the tilt linkage actuated by the rotation of the tilt shaft; and
the tilt body of the tilt platen assembly including a tilt pivot, the tilt linkage rotatably connected to the tilt pivot, the tilt body cyclically tilted by reciprocating action of the tilt linkage, and the tilt platen rotate-able on the lift frame, away from clamping alignment with the over-platen.

3. The drive and tilt system of claim 2, wherein;
the drive linkage includes a drive crank, a drive arm, and a lift shaft rocker, the drive crank mounted to the drive shaft;
the drive crank including a drive crank-arm bearing, and the drive arm rotatably attached to the drive crank at the drive crank-arm bearing;
the drive arm for connecting the drive crank at the drive crank-arm bearing to the lift shaft rocker at a drive arm-rocker bearing;
the lift shaft rocker mounted to the lift shaft, the lift shaft rocker including a drive rocker arm, and a carriage rocker arm; and
the drive rocker arm rotatably attached to the drive arm at the drive arm-rocker bearing, and the carriage rocker arm rotatably attached to the carriage rod at a carriage rod-rocker bearing.

4. The drive and tilt system of claim 2, wherein;
the lift linkage including a lift crank, and a lift arm;
the lift crank mounted to the lift shaft, the lift crank including a lift crank-arm bearing, and the lift arm rotatably attached to the lift crank at a lift crank-arm bearing; and
the lift arm includes a tilt platen-lift bearing for connecting the lift crank at the lift crank-arm bearing to the tilt body of the tilt platen assembly at the tilt platen-lift bearing.

5. The drive and tilt system of claim 3, wherein;
tilt platen-lift bearing of the lift arm rotatably connects to the lift pivot, the tilt platen assembly cyclically raised and lowered by reciprocating action of the lift arm.

6. The drive and tilt system of claim 2, wherein;
the carriage linkage includes a primary carriage rod, a primary carriage crank, a carriage shaft, a secondary carriage shaft and a secondary carriage rod;
the primary carriage rod for connecting the carriage rocker arm of the lift shaft rocker to the primary carriage crank at a primary carriage rod-rocker bearing;
the primary carriage crank mounted to the carriage shaft, the primary carriage crank including a primary carriage rod-crank bearing, and the primary carriage rod rotatably attached to the primary carriage crank at the primary carriage rod-crank bearing;
the carriage shaft including a secondary carriage crank, the secondary carriage crank rotated by action of the primary carriage crank on the carriage shaft;
the secondary carriage rod for connecting the secondary carriage crank to the carriage at a carriage-rod bearing; and
the secondary carriage crank mounted to the carriage shaft, the secondary carriage crank including a secondary carriage rod-crank bearing, and the secondary carriage rod rotatably attached to the secondary carriage crank at the secondary carriage rod-crank bearing.

7. The drive and tilt system of claim 2, wherein;
the tilt linkage including a tilt crank, and a tilt arm;
the tilt crank mounted to the tilt shaft, the tilt crank including a tilt crank-arm bearing, and the tilt arm rotatably attached to the tilt crank at the tilt crank-arm bearing;
the tilt arm for connecting the tilt crank at the tilt crank-arm bearing to the tilt body of the tilt platen assembly at a platen-tilt arm-platen bearing.

8. The drive and tilt system of claim 7, wherein;
the platen-tilt arm bearing of the tilt crank rotatably connects to the tilt pivot of the tilt body, the tilt body cyclically tilted by reciprocating action of the tilt arm, and the tilt platen rotate-able on the lift frame, away from clamping alignment with the over-platen.
